(19) United States
(12) Patent Application Publication
(10) Pub. No.: US 2010/0193645 A1
(43) Pub. Date: Aug. 5, 2010

(54) Channel joining system with a mounting channel and a joining part for joining the mounting channel to a support

(75) Inventors: Thomas Merhar, Schaan (LI); Ralph Lippuner, Buchs (CH)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/657,841

(22) Filed: Jan. 28, 2010

(30) Foreign Application Priority Data
Feb. 4, 2009 (DE) 102009000608.7-24

(51) Int. Cl. F16B 7/04

(52) U.S. Cl. 248/65

(57) ABSTRACT

The invention relates to a channel joining system (21) with a mounting channel (32) and two joining parts (22) for joining the mounting channel (32) to a support (16). The mounting channel (32) has an installation opening (36) that runs along the longitudinal extension of the mounting channel (32), that has a clear width (B) running perpendicular to the longitudinal extension and that, in one of the profile walls (34), has several fastening openings (37) that are at a distance from each other in the longitudinal extension of the mounting channel (32). The fastening openings (37) each have a clear length (L) running in the direction of the longitudinal extension of the mounting channel (32) and a clear width running perpendicular thereto. Each joining part (22) has a contact section (23), a holding section (24) and a fastening section (27). The fastening section (27; 47; 107) has an engaging section (28) that can be inserted into the mounting channel (32) and that can be rotated so as to engage behind the edges of the installation opening (36), the length of the engaging section (28) is greater than the clear width of the installation opening (36) but smaller than the clear length (L) of one of the installation openings (37), and the width (N) of the engaging section (28) is smaller than the clear width of the installation opening (36) and smaller than the clear width of a fastening opening (37).

This claims the benefit of German Patent Application DE 10 2009 000 608.7-24, filed Feb. 4, 2009 and hereby incorporated by reference herein.

The present invention relates to a channel joining system with a mounting channel and a joining part for joining the mounting channel to a support.

### BACKGROUND

In the realm of utilities in buildings, channel systems are used to which lines, for example, for water, heating, ventilation, air-conditioning and/or electric installations can easily be attached by means of suitable joining devices such as, for example, channel nuts.

For this purpose, preference is given to a so-called C-shaped mounting channel of the type known, for example, from German utility model DE 87 15 256 U1. As the profile walls, this mounting channel has two side walls arranged in parallel to each other and a rear wall that connects these side walls. The interior space enclosed by the mounting channel is accessible from the outside through an installation opening that runs along the longitudinal extension of the mounting channel, that is located opposite from the rear wall and that is laterally delimited by edges. The installation opening has a clear width running perpendicular to the longitudinal extension of the mounting channel that is smaller than the corresponding internal dimension of the interior space of the mounting channel. In the rear wall of the mounting channel, several fastening openings are provided that are at a distance from each other in the longitudinal extension of the mounting channel and through which a fastener such as, for instance, an expansion plug or a screw can be inserted, as a result of which the mounting channel can be attached, for example, directly onto a structure such as a ceiling or a wall. These fastening openings are configured as slots and they each have a clear length running in the direction of the longitudinal extension of the mounting channel and a clear width running perpendicular thereto. Pipe clamps or suspension devices can be fastened to the mounting channel by means of a joining device that has an engaging part, for example, a channel nut, that can be fastened to the mounting channel through the installation opening. In order to insert the engaging part into the interior space formed by the mounting channel, the width of the engaging part is advantageously smaller than the clear width of the installation opening and its length is advantageously greater than the clear width of the installation opening. Once the engaging part has been inserted, it is rotated in the interior space of the mounting channel and thus brought into a position for engaging behind the edges of the installation opening.

Particularly in industrial structures, the support construction usually consists of I-shaped or H-shaped steel girders. German utility model DE 299 15 435 U1 discloses a channel joining system with a clamping claw as the joining part, whereby the joining part has a contact section to be brought into contact with the mounting channel, a holding section for holding the channel joining system on a section of the support, and a U-shaped threaded rod as the fastening section for fastening the joining part to the mounting channel and for securing the channel joining system. The free ends of the U-shaped threaded rod are each provided with a threaded section onto which nuts are screwed after the threaded rod has been inserted through appropriate openings in the clamping claw. The nuts are used to bring the mounting channel into contact with the support and the entire channel joining system is detachably secured. The installation opening of the mounting channel can be aligned in different orientations relative to the support.

A drawback of this prior-art approach is that, in order to be installed, the channel joining system first has to be dismantled and secured on each side of the support with two nuts on each side, which is very laborious.

Clamping claws are available on the market that, together with the mounting channel, form a channel joining system by means of a fastener that passes through the mounting channel through the installation opening and through an opposite fastening opening in the rear wall as well as, by means of the mounting channel, by means of a plate element located on the opposite rear wall of the mounting channel. Using this channel joining system, the mounting channel can be fastened relative to the support with the installation opening towards the top and towards the bottom.

A drawback of this prior-art approach is that differently configured parts are needed for different mounting channel heights and support dimensions, which calls for excessively high logistics work for the user and the manufacturer. Moreover, the mounting channel has to be accessible from two opposite sides, which is not always ensured, for example, when the mounting channel is arranged on a support.

Furthermore, channel joining systems are available on the market with which the joining part engages directly with a fastening section in the installation opening of the mounting channel and engages behind its edges in the secured state. On the holding section of this joining part, there is a locking screw whose free end comes into contact with a section of the support when the channel joining system is secured.

A drawback of this prior-art approach is that the mounting channel can only be arranged so as to lie on a section of the support with the installation opening facing downwards relative to the support.

### SUMMARY OF THE INVENTION

It is an object of the present invention to provide a channel joining system that is easy to handle and that allows the mounting channel that is to be fastened to be flexibly oriented on the support.

The present invention provides a channel joining system with a mounting channel and at least one joining part for joining the mounting channel to a support, whereby the mounting channel has an installation opening that is delimited by edges, that runs along the longitudinal extension of the mounting channel, and that has a clear width running perpendicular to the longitudinal extension of the mounting channel and that, in at least one of the profile walls, has several fastening openings that are at a distance from each other in the longitudinal extension of the mounting channel and that each have a clear length running in the direction of the longitudinal extension of the mounting channel, and a clear width running perpendicular thereto, and whereby the joining part has a contact section for making contact with the mounting channel, a holding section for holding the channel joining system on a section of the support, and a fastening section for fastening the joining part to the mounting channel.

According to the invention, the fastening section of the joining part has an engaging section that can be inserted into the mounting channel and that can be rotated so as to engage behind the edges of the installation opening, whereby the length of the engaging section is greater than the clear width of the installation opening but smaller than the clear length of one of the installation openings, and whereby the width of the engaging section is smaller than the clear width of the installation opening and smaller than the clear width of a fastening opening.

Due to this configuration of the engaging section, the fastening section can be inserted through the installation opening as well as through a fastening opening so as to engage behind the appertaining edges into the interior space defined by the mounting channel. The orientation of the mounting channel relative to the support can be such that the installation opening of the channel comes to lie facing said support or facing away from said support. Largely identical parts can be used for mounting channels of different sizes or for different support dimensions, as a result of which the logistical work during the installation, storage and production is considerably reduced when the channel joining system according to the invention is used. Moreover, the channel joining system according to the invention can be installed simply and quickly.

Preferably, on one side of the engaging section that faces the joining part, a shoulder is provided whose width is maximally the width of the engaging section and whose length is maximally the clear width of the installation opening. Normally, the fastening openings have a clear width that is smaller than the clear width of the installation opening. Moreover, the free ends of the edges that delimit the installation opening are bent towards the inside. When the joining part is arranged on the side of the mounting channel that has the installation opening, then, in the secured state of the channel joining system, the securing surfaces of the engaging section come into contact with the edges that delimit the mounting channel, and the shoulder comes to lie in the space between the edges that delimit the installation opening. When the joining part is arranged on the side of the mounting channel that has the fastening openings, then, in the secured state of the channel joining system, the securing surfaces of the shoulder come into contact with the edges that delimit the corresponding fastening opening. The shoulder on the engaging section thus compensates for the different clamping heights between the installation opening and the fastening openings.

Preferably, the engaging section and the joining part are configured as a single piece and especially advantageously as a punched and bent part. Such joining parts are easy to handle and cost-effective to produce. As an alternative, the joining part is made of cast metal.

In an alternative according to the invention, the engaging section is connected to a shaft that can pass through a passage opening in a joining element of the joining part. The joining element is a separate part that has the contact section and, at a distance from it, the holding section. Especially advantageously, the engaging section is the head part of a hammer head bolt. The passage opening for the shaft is located between the contact section and the holding section of the joining element. The channel joining system according to the invention is secured by means of a nut arranged on the shaft.

Preferably, the passage opening is a slot whose longitudinal extension runs parallel to a direction running from the contact section to the holding section, as a result of which the channel joining system can accommodate many different support dimensions with one kind of joining part.

Preferably, the shaft is provided on opposite sides with a flattened area and the distance of these flattened areas from each other corresponds maximally to the width of the passage opening in the joining element, as a result of which the joining element is non-rotatably secured to the shaft.

Preferably, the contact section has two surrounding sections to surround two opposite outer edges of the mounting channel in certain areas, whereby their clear distance corresponds at least to the distance of these edges of the mounting channel. The surrounding sections ensure an advantageous positioning and orientation of the joining part to the mounting channel in the secured state of the channel joining system.

### BRIEF DESCRIPTION OF THE DRAWINGS

The present invention is described in greater detail below with reference to embodiments. The following is shown:

FIG. 1 a first embodiment of a channel joining system in a partial longitudinal section;

FIG. 2 a cross section only through the mounting channel along line II-II in FIG. 1;

FIG. 3 a cross section along line II-II in FIG. 1, with a joining part arranged in the installation opening of the mounting channel;

FIG. 4 a cross section analogous to FIG. 3, with a joining part arranged in a fastening opening of the mounting channel;

FIG. 5 a front view of a second embodiment of a joining part;

FIG. 6 a side view of the joining part according to FIG. 5;

FIG. 7 a front view of a third embodiment of a joining part;

FIG. 8 a side view of the joining part according to FIG. 7;

FIG. 9 a plan view of the joining part according to FIG. 7;

FIG. 10 a perspective view of a fourth embodiment of a channel joining system; and

FIG. 11 a perspective view of a fifth embodiment of a joining part.

### DETAILED DESCRIPTION

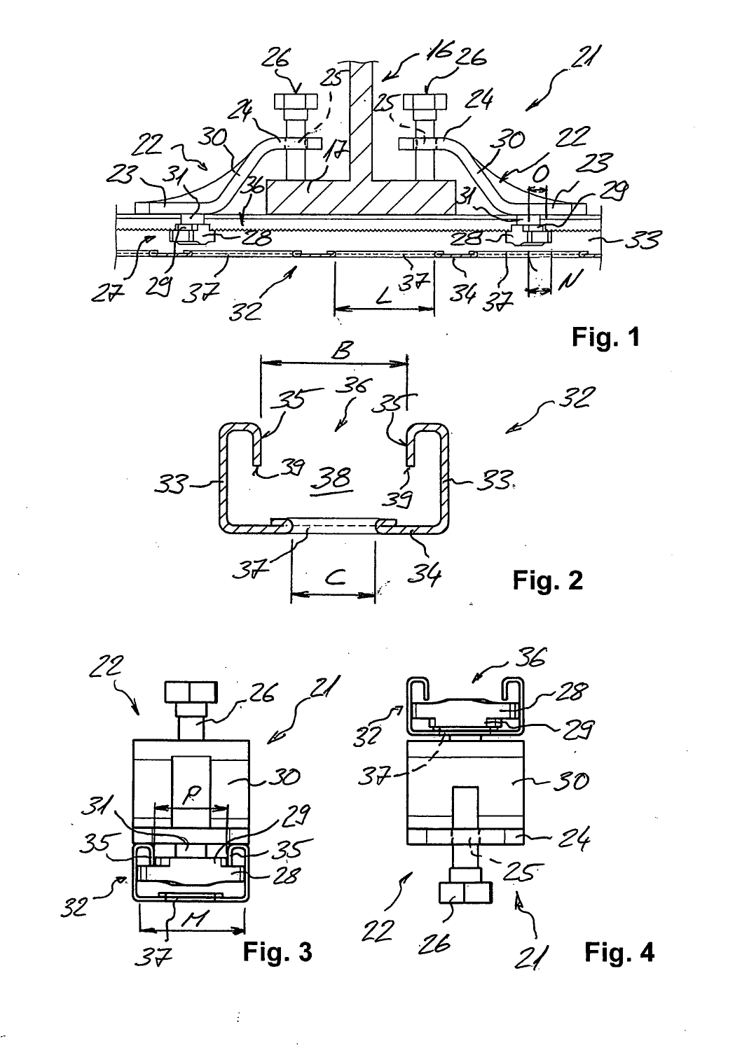

The channel joining system 21 shown in FIGS. 1 to 4 for joining a mounting channel 32 to a support has two joining parts 22 and a mounting channel 32.

As the profile walls, the mounting channel 32 has two opposite side walls 33, a rear wall 34 that connects these side walls 33 and, opposite from this rear wall 34, an installation opening 36 that is delimited by edges 35 and that runs in the longitudinal extension of the mounting channel 32. The installation opening 36 has a clear width B that runs perpendicular to the longitudinal extension of the mounting channel 32, and this clear width B is defined by the free ends 39 of the edges 35 that are bent towards the inside. The free ends 39 of the edges 35 are provided with teeth. In the rear wall 34, several fastening openings 37 are provided that are at a distance from each other in the longitudinal extension of the mounting channel 32 and that each have a clear length L running in the direction of the longitudinal extension of the mounting channel 32 as well as a clear width C running perpendicular thereto. The fastening openings 37 have edges that, in this embodiment, are completely flanged. The profile walls enclose an interior space 38 that is enclosed by the mounting channel 32 and that is accessible, on the one hand, through the installation opening 36 and, on the other hand, from the outside through the fastening openings 37.

Each joining part 22 has a contact section 23 for contact with the mounting channel 32, a holding section 24 for holding the channel joining system 21 on a flange 17 as a section of a support 16, and a fastening section 27 for fastening the joining part 22 to the mounting channel 32. In the holding section 24, a passage bore 25 that has an internal thread is provided into which a locking screw 26 is screwed. The contact section 23 and the holding section 24 are connected to each other by means of a joining section 30. The contact section 23 defines a plane that is at a distance from a plane defined by the holding section 24.

The fastening section 27 of the joining part 22 has a rotatable engaging section 28 that can be inserted into the interior space 38 of the mounting channel 32 and that serves to engage behind the edges 35 of the installation opening 36 of the mounting channel 32. The width M of the engaging section 28 is larger than the clear width B of the installation opening 36, but smaller than the clear length L of one of the fastening openings 37. The width N of the engaging section 28 is smaller than the clear width B of the installation opening 36 and smaller than the clear width C of a fastening opening 37. On one side of the engaging section 28 facing the joining part 22, a shoulder 29 is provided whose width O corresponds maximally to the width N of the engaging section 28 and whose length P corresponds maximally to the clear width B of the installation opening 36. Via a shaft 31, the engaging section 28 is at a distance from the contact section 23 and is thus configured as a single piece with the joining part 22.

In FIG. 3, the joining part 22 is arranged on the side of the mounting channel 32 that has the installation opening 36, whereby the securing surfaces of the engaging section 28 are in contact with the free ends 39 of the edges 35 of the mounting channel 32. The shoulder 29 provided on the engaging section 28 comes to lie in the space between the edges 35.

In FIG. 4, the joining part 22 is arranged on the side of the mounting channel 32 that has the fastening openings 37, whereby the securing surfaces of the shoulder 29 provided on the engaging section 28 are in contact with the edges that delimit the appertaining fastening openings 37.

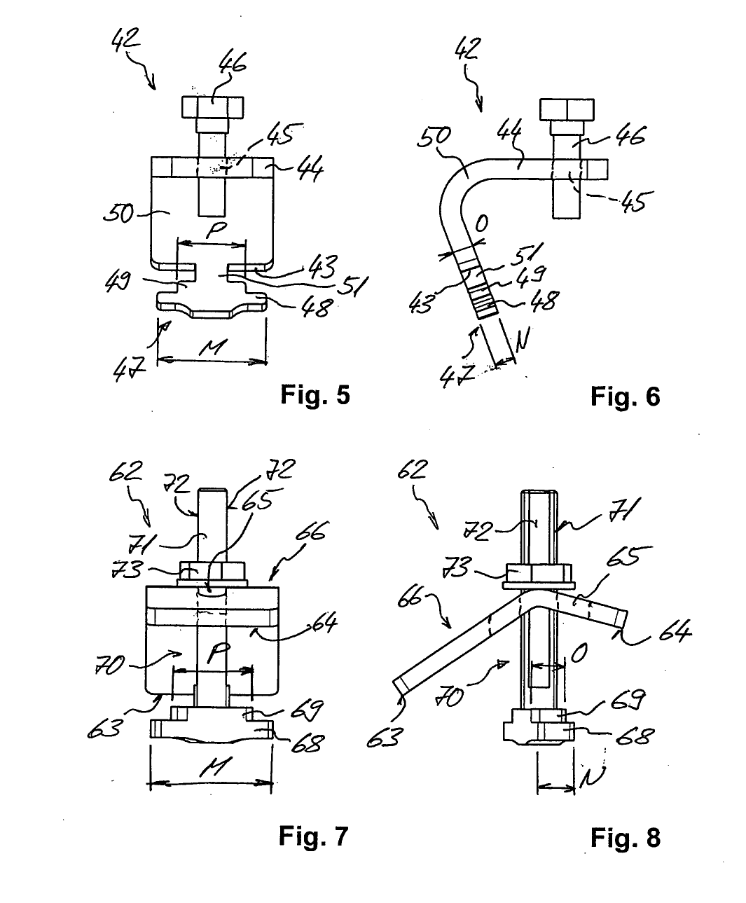

The embodiment of a joining part 42 shown in FIGS. 5 and 6 is a punched and bent part. This joining part 42 likewise has a contact section 43 for contact with the mounting channel 32, a holding section 44 for holding the channel joining system on a flange 17 as a section of a support 16, and a fastening section 47 for fastening the joining part 42 to the mounting channel 32. In the holding section 44, a passage bore 45 having an internal thread is provided into which a locking screw 46 is screwed. The contact section 43 and the holding section 44 are joined to each other via a bent joining section 50 that encloses an acute angle of less than 90°.

This fastening section 47 has an engaging section 48, whereby the length M of the engaging section 48 is larger than the clear width B of an installation opening of a mounting channel that, together with the joining part 42, forms a channel joining system, but that is smaller than the clear length L of one of the fastening openings of the corresponding mounting channel. The width N of the engaging section 48 is smaller than the clear width B of the installation opening and smaller than the clear width C of a fastening opening 37 of the corresponding mounting channel. On one side of the engaging section 48 facing the joining part 42, a shoulder 49 is provided whose width O corresponds maximally to the width N of the engaging section 48 and whose length P corresponds maximally to the clear width B of the installation opening of the corresponding mounting channel. The engaging section 48 is at a distance from the contact section 43 via a joining section 51 and is thus configured as a single piece with the joining part 42.

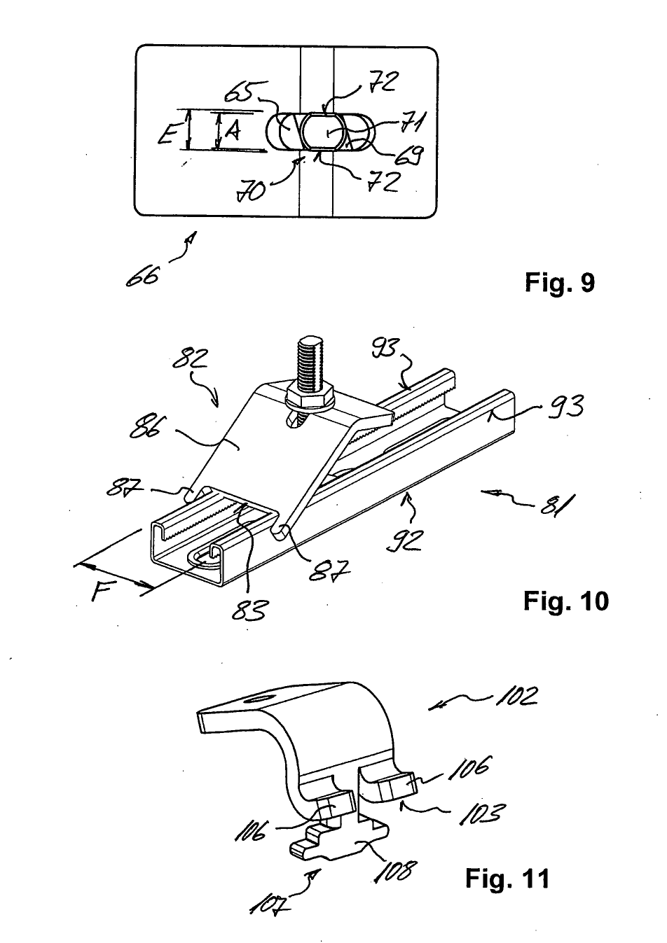

FIGS. 7 to 9 show a multi-part joining part 62 that has a joining element 66 and a hammer head bolt 70. The joining element 66 is a punched and bent part with a bent segment, whereby the legs of the joining element 66 enclose an obtuse angle. One end edge of the joining element 66 forms the contact section 63 of the joining part 62, whereby the opposite end edge of the joining element 66 forms the holding section 64 of the joining part 62. Between the contact section 63 and the holding section 64, a passage opening 65 configured as a slot is provided whose longitudinal extension runs parallel to a direction running from the contact section 63 to the holding section 64.

The hammer head of the hammer head bolt 70 forms the engaging section 68 of the joining part 62. This engaging section 68 also has a shoulder 69. The engaging section 68 as well as the shoulder 69 are configured as in the embodiments described above. A shaft 71 having a thread—at least in certain areas—is provided as a single piece together with the engaging section 68 or with the shoulder 69, and this shaft 71 is provided on opposite sides with flattened areas 72. The distance A of these flattened areas 72 relative to each other corresponds maximally to the width E of the passage opening 65 in the joining element 66.

The shaft 71 passes through the passage opening 65 in the joining element 66. A nut 73 is provided on the thread of the shaft 71 and, by means of this nut 73, the channel joining system can be secured after the engaging section 68 has been positioned in the mounting channel.

The joining part 82 of the channel joining system 81 shown in FIG. 10 differs from the previously described joining part 62 only in that the contact section 83 of the joining element 86 has two engaging sections 87 for engaging around areas of two opposite outer edges 93 of the mounting channel 92 in the same plane, and their clear distance is greater than the distance F of these edges 93 of the mounting channel 92.

The joining part 102 according to FIG. 11 is configured essentially as a single piece and, like the joining part 42 shown in FIGS. 5 and 6, is a punched and bent part. However, the joining part 102 shown here differs in the configuration of its contact section 103, which is formed by two noses 106 protruding towards the outside. The fastening section 107 with the engaging section 108 protrudes between the noses 106.

What is claimed is:

1. A channel joining system comprising:
a mounting channel having profile walls; and
at least one joining part for joining the mounting channel to a support,
the mounting channel having an installation opening delimited by edges, the installation opening running along a longitudinal direction of the mounting channel and having a clear width running perpendicular to the longitudinal direction of the mounting channel,
at least one of the profile walls having several fastening openings at a distance from each other in the longitudinal direction of the mounting channel, each fastening opening having a clear length running in the longitudinal direction, and a clear width running perpendicular thereto,
the joining part having a contact section for contacting the mounting channel, a holding section for holding the channel joining system on a section of the support, and a fastening section for fastening the joining part to the mounting channel,
the fastening section of the joining part having a rotatable engaging section insertable into the mounting channel and serving to engage behind the edges of the installation opening, a length of the engaging section being greater than the clear width of the installation opening but smaller than the clear length of one of the installation openings, a width of the engaging section being smaller than the clear width of the installation opening and smaller than the clear width of a fastening opening.

2. The channel joining system as recited in claim 1 wherein on one side of the engaging section facing the joining part, a shoulder is provided whose width corresponds maximally to the width of the engaging section and whose length corresponds maximally to the clear width of the installation opening.

3. The channel joining system as recited in claim 1 wherein the engaging section and the joining part are configured as a single piece.

4. The channel joining system as recited in claim 1 wherein the engaging section is connected to a shaft passable through a passage opening in a joining element of the joining part.

5. The channel joining system as recited in claim 4 wherein the passage opening is a slot whose longitudinal extension runs parallel to a direction running from the contact section to the holding section.

6. The channel joining system as recited in claim 5 wherein the shaft is provided on opposite sides with a flattened area and the distance of the opposite flattened areas from each other corresponds maximally to the width of the passage opening in the joining element.

7. The channel joining system as recited in claim 4 wherein the contact section has two surrounding sections to surround two opposite outer edges of the mounting channel in certain areas, a clear distance of the two surrounding sections corresponding at least to a distance between the edges of the mounting channel.
